(19) United States
(12) Patent Application Publication
(10) Pub. No.: US 2006/0256380 A1
(43) Pub. Date: Nov. 16, 2006

(54) Transparent digital images and method of processing and storing same

(76) Inventors: Gary D. Klassen, Waterloo (CA); Brian A. Young, Waterloo (CA); Darcy Richard Phipps, Waterloo (CA)

Correspondence Address: BORDEN LADNER GERVAIS LLP, WORLD EXCHANGE PLAZA, 100 QUEEN STREET SUITE 1100, OTTAWA, ON, K1P 1J9, CA

(21) Appl. No.: 11/125,078

(22) Filed: May 10, 2005

(51) Int. Cl. G06K 15/00

(52) U.S. Cl. 358/1.16; 358/1.2

(57) ABSTRACT

A method of reducing a storage size of a digital image file without affecting display quality of the digital image, comprising the steps of splitting the image into a first component and a second component; encoding the first component as a lossy compression component; encoding the second component as a lossless transparency component; and associating the lossy compression component and the lossless transparency component.

A portion of the disclosure of this patent document contains material which is subject to protection. The copyright owner has no objection of the facsimile reproduction by any one of the patent document or patent disclosure, as it appears in the Patent and Trademark Office patent file or records, but otherwise reserves all copyrights whatsoever.

### FIELD OF THE INVENTION

The embodiments of the invention relate generally to digital images. More particularly, the embodiments of the invention relate to transparent digital images and a method of processing and storing the digital images.

### BACKGROUND OF THE INVENTION

Digital images, such as computer images, are well known and many people come in regular contact with these images. From individuals who interact with the Internet to individuals who have computers or mobile communication devices which display graphics, such as icons, interaction with computer images are a common daily occurrence for most people. With the invention of digital cameras, digital photographs may also be directly uploaded to a computer for viewing by other individuals.

There are many different formats for digital images such as Tagged Image File Format (TIFF), Bitmap (BMP), Joint Photographic Expert Groups (JPEGs), Graphic Interchange Format (GIFs) or Portable Network Graphics (PNGs). JPEG images are generally known to efficiently encode images with lots of colour information by removing the redundancy information from photo-realistic images that are not important to the human eye. The images are compressed to reduce the amount of information in the image, rather than just the number of bits used to represent that information. The lost information is usually removed because it is subjectively less important to the quality of the image or because it can be recovered reasonably by interpolation from the remaining data. For this reason, JPEGS are also known as being lossy. GIF or PNG images use a colour palette and are capable of efficiently encoding images with limited colour information so that they are able to support the concept of transparent or semi-transparent images with all of the original image data being retained. For this reason, digital images such as GIFs and PNGS are known as being lossless.

However, when there is an image that contains photo-realistic colour information and transparency information, JPEG compression may not be used since it does not support transparency and the image must be stored and displayed as a GIF or PNG image which is a less effective manner to store and display the image since GIF images cause a reduction in colour definition while PNG images result in less efficient compression.

It is, therefore, desirable to provide a novel transparent digital image and a method for processing and storing same.

### BRIEF DESCRIPTION OF THE DRAWINGS

Embodiments of the invention will now be described, by way of example only, with reference to the attached Figures, wherein:

FIG. 1 is a schematic diagram of apparatus for processing and storing a digital image.

FIG. 2 is a schematic diagram of a digital image.

FIG. 3 is a flowchart outlining an embodiment of a method of processing and storing a digital image.

### DETAILED DESCRIPTION

It is an aspect to obviate or mitigate at least one disadvantage of previous methods of processing and storing digital images. It is another aspect to provide a novel digital image format.

Generally, there is provided a digital image and a method and system for processing and storing the digital image. The method allows for the byte size of an image file to be reduced without affecting the appearance of the image when it is displayed to a user.

In a first aspect, there is provided a method of reducing a storage size of a digital image file without affecting display quality of the digital image, comprising the steps of splitting the image into a first component and a second component; encoding the first component as a lossy compression component; encoding the second component as a lossless transparency component; and associating the lossy compression component and the lossless transparency component.

In another aspect, there is provided a digital image comprising a lossy compression component; and a lossless transparency component, associated with the lossy compression component.

In yet a further aspect, there is provided a memory for storing data for access by an application program being executed on a data processing system, comprising a data structure stored in the memory, the data structure including information resident in a database used by the application program and including a lossy compression component; and a lossless transparency component, associated with the lossy compression component.

Digital images are generally full colour (RGB) images or full colour and full transparency (RGBa) images. RGBa images differ from RGB images in that they include a transparency level for each individual pixel in the image. This is achieved by adding an alpha channel to the three basic Red, Green and Blue channels using an effect known as alpha transparency.

As will be understood, the appearance of each pixel in an RGBa image is defined by four values: a Red (R) value which represents the amount of red in the pixel colour, a Green (G) value which represents the amount of green in the pixel colour, a Blue (B) value which represents the amount of blue in the pixel colour and an alpha channel value (a) that specifies the transparency of that particular pixel in a range from 0 (completely transparent) to 255 (fully opaque). The use of RGB or RGBa values to define a pixel colour will be well known to one skilled in the art. Greyscale images may also be processed in a similar manner.

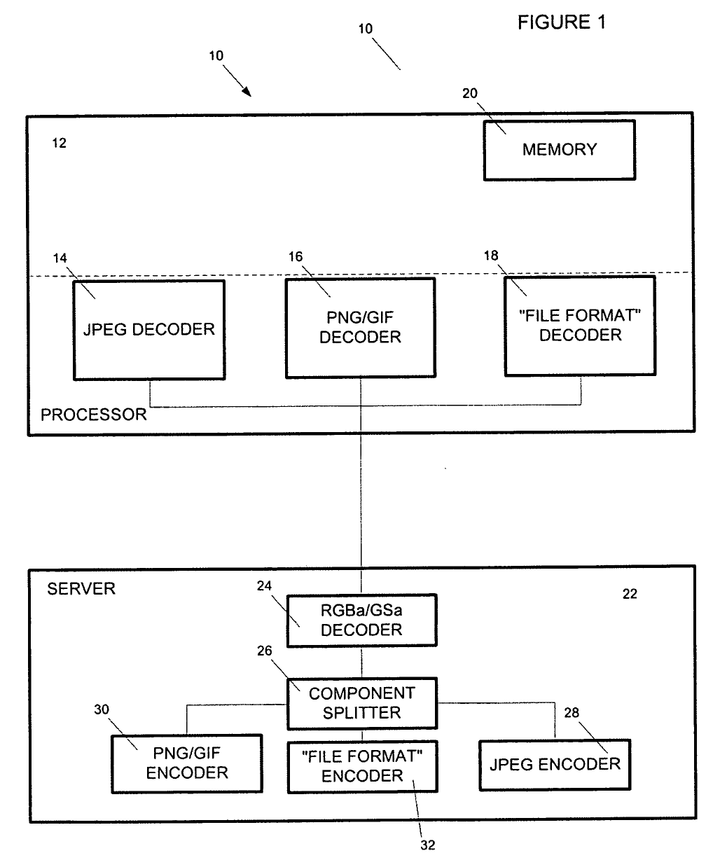

Turning to FIG. 1, a schematic diagram of apparatus for processing and storing a transparent digital image is shown.

A device 10, such as a computer or a mobile communication device, comprises a processor 12 which preferably includes a first decoder 14, preferably a JPEG decoder, a second decoder 16, preferably a PNG/GIF decoder and a third decoder 18, preferably a “File Format” decoder. The file format decoder 18 may allow for other file formats (not including JPEG, PNG and/or GIF) to also be processed. The device 10 also comprises memory 20 for storing files such as a digital image file. The device 10 may also be in communication with a server 22, storing digital image files, either wirelessly or via a connected cable.

The server 22 preferably comprises an RGBa/Gsa decoder 24 which is connected to a component splitter 26. The component splitter is also connected to a first encoder 28, preferably a Joint Photographic Experts Group (JPEG) encoder, a second encoder 30, preferably a Portable Network Graphic/Graphic Interchange Format (PNG/GIF) encoder and a third encoder 32, preferably a “File Format” encoder which corresponds with the “file format” decode 18 in the device 10. Although the following description is directed at the use of JPEG/PNG/GIF files, it will be understood that other file formats may be processed via the “file format” encoder and decoder. The file format encoder and decoder may also have the added functionality of associating the colour and transparency components of the image file, as will be described below.

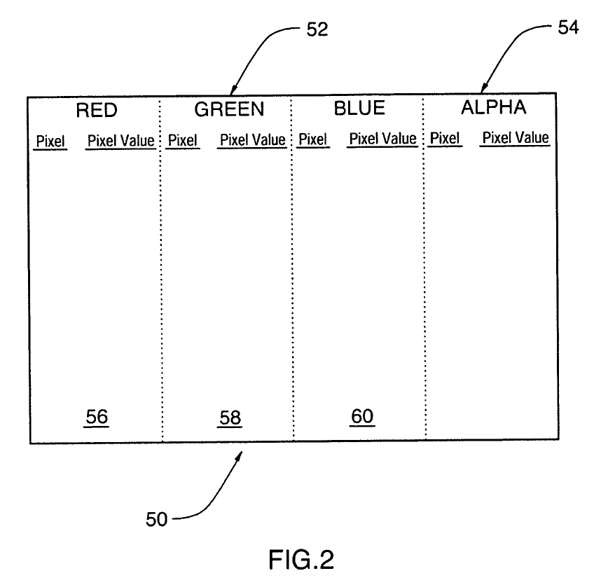

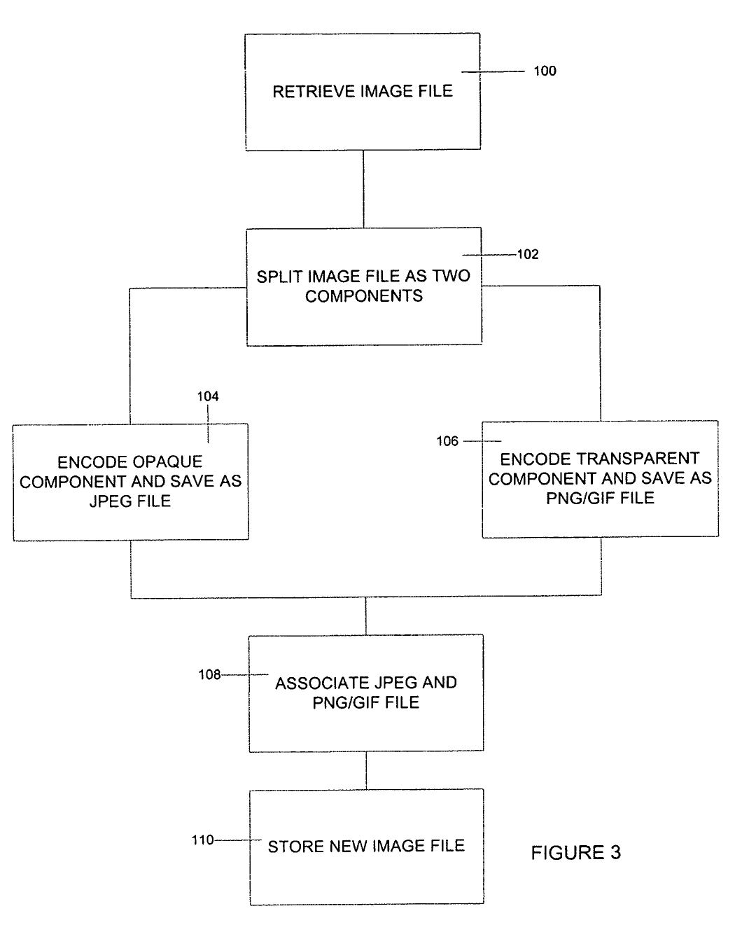

Turning to FIG. 2, a schematic diagram of a digital image produced by the method of FIG. 3 is shown. The image 50 comprises a first component 52, or colour component, which represents a lossy compressed section and a second component 54 or transparency component, which represents a lossless transparency section. The first component 52 comprises a set of R (56), G(58) and B(60) values which represent the compressed RGB values of the pixels of the image while the second component 54 represents the alpha channel value of the pixels of the image.

Turning to FIG. 3, a method of processing and storing a digital image is shown. Firstly, a digital image file, having an alpha component, such as an RGBa image file, is retrieved by the processor 12 of the device 10 (step 100), which is preferably a computer or a mobile communication device. The digital image file may be stored in memory 20 within the device 10 or retrieved from the server 22 with which the device 10 is in communication.

After the RGBa image file is retrieved by the processor 12, the digital image file is split into a first and a second component: the first component being the colour component and the second component being the transparency component (step 102). The colour component of the image file refers to the set of true colour (RGB) values for each pixel of the image while the transparency component is the set of alpha channel values (a) for each pixel of the image.

The step of splitting preferably comprises the steps of retrieving the RGBa values from the digital image and then decoding, via the RGBa/Gsa decoder 24, the values to extract the first component and the second component. After the file is decoded, the image file is transmitted to the component splitter 26 which splits the image file into the first and second components.

After splitting the components, the colour component is transmitted to the JPEG encoder 28 and encoded using JPEG Lossy Compression Encoding with discrete cosine transforms (DCT) and saved as a JPEG file (step 104) while the transparency component is transmitted to the PNG/GIF encoder 30 and encoded as a PNG or GIF file (step 106). The transparency component is simply the alpha channel values for each pixel from the initial RGBa image in a lossless format. Encoding of these two components preferably results in the JPEG file (step 104) representing a lossy compression component and the PNG or GIF file representing a lossless transparency component as shown in FIG. 2.

Although not necessary, it is preferred that the JPEG encoder and the PNG/GIF encoder perform these steps consecutively. However, in an alternative embodiment, the encoding may be done concurrently. Furthermore, the second component may be encoded before the first component. Use of these types of encoders will be known to one skilled in the art of digital image rendering.

After being encoded, the two files are then associated with each other (step 108). This association may be performed by the file format encoder 32 and file format decoder 18. The two files may also be associated with the file name of the initial digital image so that when the processor calls the initial image, the new image (created by the association of the two files) may be displayed on a device display screen to the individual. In this manner, a new file format may be appreciated which allows the overall size of an RGBa image to be reduced without affecting the quality of the image when displayed. This is more clearly shown in FIG. 5. In order for current image viewers, such as Adobe™ Photoshop™ to be able to decode this file format, the format must be defined which may require that current image viewers be updated in order to handle this new file format.

It will be understood that this association may be accomplished in various ways. In one embodiment, the two files are recombined to form a single file. When the image is called by the processor 12, the JPEG file and the PNG or GIF file are decoded by the JPEG decoder 14 and the PNG/GIF decoder 16, respectively. In the apparatus shown in FIG. 1, there are two decoders (one being the JPEG decoder 14 and the second being the PNG/GIF decoder 16), however, there may be only one decoder which is capable of decoding both JPEG and PNG or GIF files.

Alternatively, simple naming conventions of the two files may be used to associate the files with the initial image or pointers which indicate to the processor that the files for the initial image may be found at another location (namely the memory location where the JPEG and PNG or GIF files are stored). Another method of associating the files is to embed the JPEG file into the PNG or GIF file or vice versa. In this case, it is preferred that the PNG or GIF file is filed as an application extension block in the JPEG file so when the image is to be displayed, only a single file is called rather than multiple files.

This method is generally automatically executed each time an image is retrieved by the processor, dynamically (for immediate display) or passively (for future display) therefore allowing the new image data to be compiled (decoded) at run time without requiring modification to the application on the processor calling the image. The images may also be cached in order to save processing time each time the image is called by the device.

One method of processing the image for display is to insert the JPG component of the image and then to apply the transparency component to the image.

Although this method of processing digital images may be used with respect to any digital images, it is more useful in the field of mobile communication devices since there is a relatively large memory savings when the initial RGBa image is transferred from a full colour, full transparency image to the digital image. As indicated above, by splitting the initial image into two components and encoding the two components separately, a reduction in overall file size is achieved

For instance, in one example, a full colour, full transparency digital image file having a size of 227529 bytes was retrieved by the processor. After splitting the image file into the colour and transparency components, the colour component was encoded and saved in a JPEG file having a size of 60639 bytes while the transparency component was encoded and saved as a PNG file having a size of 17279 bytes. After associating the two new files, the size of the new image file was 77918 bytes which is a reduction of 149611 bytes from the original image file. This extra memory may then be used to store other data or more digital image files. The reduction in file size also allows for the new images to be more easily transferred or emailed since many servers restrict the size of emails to a predetermined size.

Although described as using RGB and RGBa images, it will be understood that the method may also be applied to Hue Saturation Value (HSV) and HSVa images as well.

The above-described embodiments are intended to be examples only. Alterations, modifications and variations may be effected to the particular embodiments by those of skill in the art without departing from the scope of the invention, which is defined solely by the claims appended hereto.

What is claimed is:

1. A method of reducing a storage size of a digital image file without affecting display quality of said digital image, comprising the steps of:
splitting said image into a first component and a second component;
encoding said first component as a lossy compression component;
encoding said second component as a lossless transparency component; and
associating said lossy compression component and said lossless transparency component.

2. The method of claim 1 further comprising, occurring before the step of splitting, the step of:
retrieving said digital image file.

3. The method of claim 2 wherein said step of retrieving comprises the step of:
retrieving said digital image file from a memory.

4. The method of claim 2 wherein said step of retrieving comprises the step of:
retrieving said digital image file from a server.

5. The method of claim 1 wherein said step of encoding said first component comprises the steps of:
compressing said first component using Joint Photographic Experts Group (JPEG) Lossy Compression Encoding with discrete cosine transforms (DCT)

6. The method of claim 1 wherein said step of splitting comprises the steps of:
retrieving colour information from said digital image as said first component; and
retrieving transparency information from said digital image as said second component.

7. The method of claim 1 wherein said step of associating comprises the steps of:
combining said lossy compression component and said lossless transparency component as a single file.

8. The method of claim 7 wherein said step of combining comprises the step of:
embedding said lossy compression component within said lossless transparency component.

9. The method of claim 7 wherein said step of combining comprises the step of:
embedding said lossless compression component within said lossy compression component.

10. The method of claim 9 wherein said step of embedding comprises the step of:
storing said lossless compression component as an application extension block in said lossy compression component.

11. The method of claim 1 wherein said step of associating comprises the step of:
naming said lossy compression component and said lossless transparency component in accordance with a predetermined naming convention;
wherein said predetermined naming convention causes said lossy compression component and said lossless transparency component to have associated names.

12. A memory for storing data for access by an application program being executed on a data processing system, comprising:
a data structure stored in said memory, said data structure including information resident in a database used by said application program and including:
a lossy compression component; and
a lossless transparency component, associated with said lossy compression component.

13. The memory of claim 12 wherein said lossy compression component is a compressed JPEG file.

14. The memory of claim 13 wherein said compressed JPEG file is a set of compressed RGB values which have been compressed from an initial digital image.

15. The memory of claim 12 wherein said lossless transparency component is a PNG or GIF file.

16. The memory of claim 15 wherein said PNG or GIF file is a set of alpha channel values.
